(19) United States
(12) Patent Application Publication
(10) Pub. No.: US 2011/0181165 A1
(43) Pub. Date: Jul. 28, 2011

(54) LIGHT EMITTING DIODE LAMP

(76) Inventors: Shun-Tian LIN, Shulin (TW); Yun-Tzu Chen, Shulin (TW); Jung-Hsuan Lin, Shulin (TW); Hui-Hsuan Chang, Shulin (TW)

(21) Appl. No.: 12/692,553

(22) Filed: Jan. 22, 2010

(51) Int. Cl. H01J 61/52; H01J 5/48

(52) U.S. Cl. 313/46; 313/318.01

(57) ABSTRACT

A light emitting diode (LED) lamp has a seat with a base, a cover mounted on the seat, and an AC fan, a heat sink and an AC LED light source mounted in the seat. The AC fan and the AC LED light source are electrically connected to the base of the seat. An AC directly provides to and drives the AC fan and the AC LED light source and no converter module is needed. Therefore, the LED lamp is quiet, energy saving and has good heat dissipation and low manufacturing costs for a prolonged operating life.

### BACKGROUND OF THE INVENTION

1. Field of the Invention

The present invention relates to a light emitting diode (LED) lamp, especially to a lamp using LEDs as a light source.

2. Description of the Prior Art(s)

With rising energy costs environmental consciousness, conventional incandescent bulbs having low energy conversion efficiency will be eventually gradually replaced by lower-energy variants, such as fluorescent, halogen and light emitting diode (LED) lamps. Of the foregoing, LEDs have longer operating lives so gain greater energy efficiency when production and transportation energy is included in such measures.

With reference to FIGS. 5 and 6, a conventional LED lamp comprises a seat (21) having a base (211), a heat sink (22) and a direct current (DC) LED module (23) mounted on a top of the seat (21), and a DC fan (24) and a converter module (25) mounted in the seat (21). The heat sink (22) conducts heat generated by the DC LED module (23). The DC fan (24) further dissipates the heat from the heat sink (22). The converter module (25) converts AC to DC and has multiple wires (26) respectively connected electrically to the base (211), the DC fan (24) and the DC LED module (23). Therefore, as the base (211) is inserted in a socket, the AC provided by a domestic power supply is converted to the DC through the converter module (25) and drives the DC fan (24) and the DC LED (23).

However, the conventional LED lamp with the converter module (25) has the following disadvantages.

When the converter module (25) converts the AC to the DC, power loss occurs and unnecessary heat is generated. Consequently, energy is wasted and temperature of the conventional LED lamp is hard to be lowered causing failure of the conventional LED lamp.

The converter module (25) and assembling the converter module (25) causes high manufacturing cost of the conventional LED lamp. Moreover, the converter module (25) has an operating life shorter than the DC LED module (23). Therefore, when the converter module (25) breaks, although the DC LED module (23) still works, the conventional LED lamp cannot be used anymore.

Since the temperature of the conventional LED lamp is high, the DC fan (24) for the conventional LED lamp needs to have rotational speeds higher than 4000 rotation per minute (RPM) and consequently generates noise.

To overcome the shortcomings, the present invention provides an LED lamp to mitigate or obviate the aforementioned problems.

### SUMMARY OF THE INVENTION

The main objective of the present invention is to provide a light emitting diode (LED) lamp. The LED lamp has a seat with a base, a cover mounted on the seat, and an AC fan, a heat sink and an AC LED light source mounted in the seat. The AC fan and the AC LED light source are electrically connected to the base of the seat.

An AC directly drives the AC fan and the AC LED light source and no converter module is needed. Therefore, the LED lamp is quiet, energy saving and has good heat dissipation and low manufacturing costs for a prolonged operating life.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a light emitting diode (LED) lamp in accordance with the present invention;

FIG. 2 is an exploded perspective view of the LED lamp in FIG. 1;

FIG. 3 is a side view in partial section of the LED lamp in FIG. 1;

FIG. 4 is a perspective view of another embodiment of a LED lamp in accordance with the present invention;

FIG. 5 is an exploded perspective view of a conventional LED lamp in accordance with the prior art; and

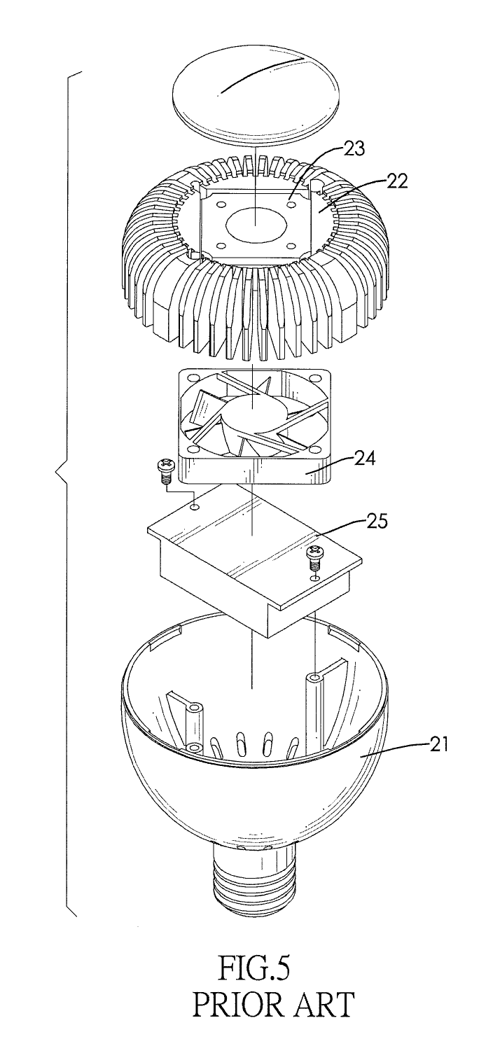

FIG. 6 is a side view in partial section of the LED lamp in FIG. 4.

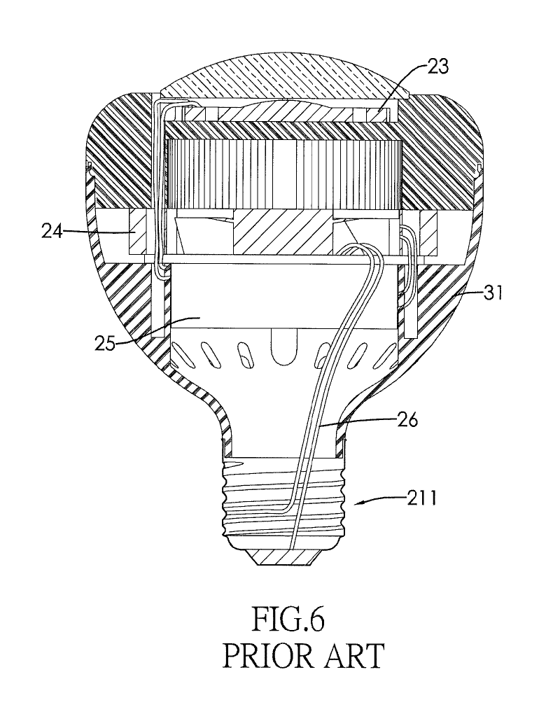

### DETAILED DESCRIPTION OF THE PREFERRED EMBODIMENTS

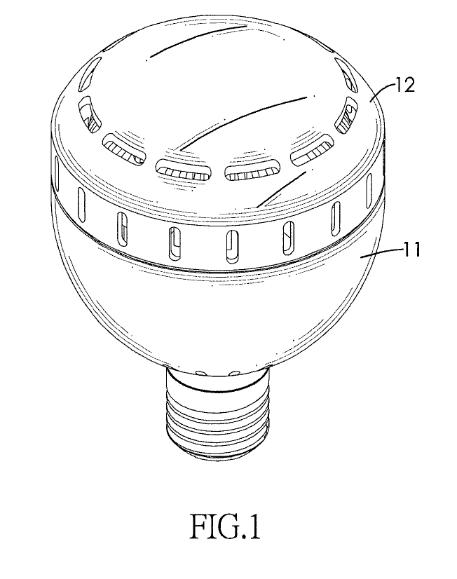

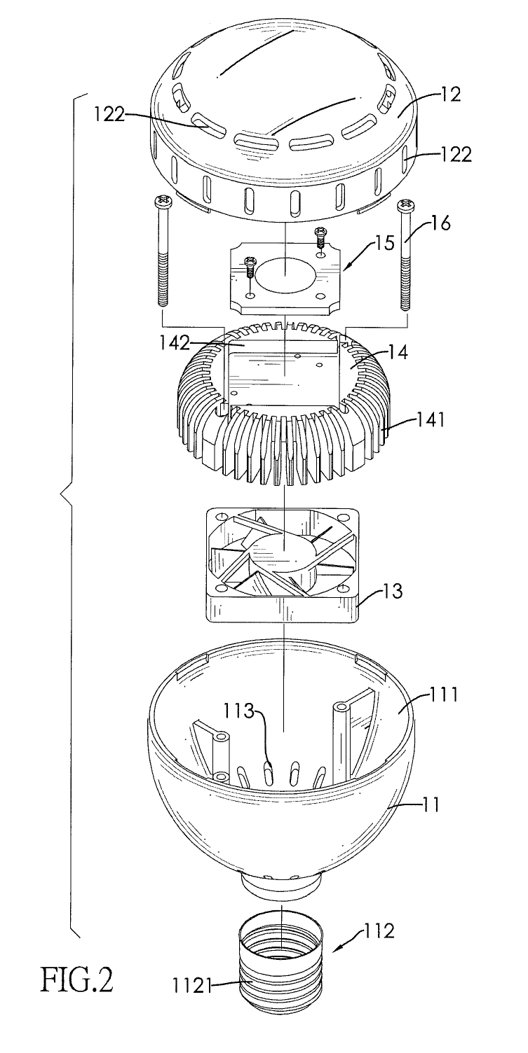

With reference to FIGS. 1 and 2, a light emitting diode (LED) lamp in accordance with the present invention comprises a seat (11), a cover (12), an alternating current (AC) fan (13), a heat sink (14), multiple fasteners (16) and an AC LED light source (15, 15A).

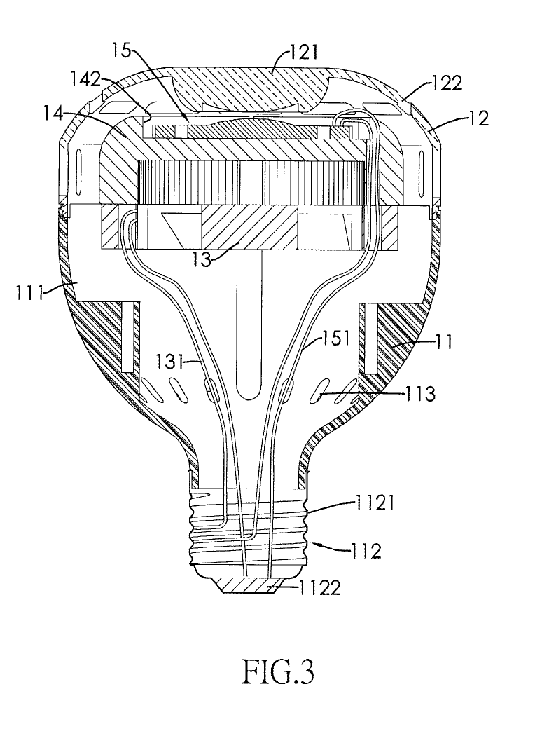

With further reference to FIG. 3, the seat (11) has a mounting recess (111), a base (112) and multiple rear vents (113). The mounting recess (111) is formed in a top of the seat (11). The base (112) is mounted on a bottom of the seat (11) and has two AC contacts (1121, 1122). The rear vents (113) are formed through the seat (11) and communicate with the mounting recess (111).

The cover (12) is pervious to light, is mounted on the top of the seat (11) and has a lens (121) and multiple front vents (122). The lens (121) gathers light and may be transparent. The front vents (122) are formed through the cover (12).

The AC fan (13) is mounted in the mounting recess (111) of the seat (11) and has two fan wires (131). The fan wires (131) are respectively connected electrically to the AC contacts (1121, 1122) of the base (12).

The heat sink (14) is mounted in the mounting recess (111) of the seat (11) and between the cover (12) and the AC fan (13) and has multiple fins (141) and a storing recess (142). The storing recess (142) is formed in a top of the heat sink (14) and corresponds to the cover (12).

The fasteners (16) are mounted through the heat sink (14) and the AC fan (13) and are fastened to the seat (11) to securely hold the heat sink (14) and the AC fan (13) on the seat (11).

The AC LED light source (15, 15A) is mounted in the mounting recess (111) of the seat (11), is securely mounted in the storing recess (142) of the heat sink (14), corresponds to the cover (12) and has multiple LED wires (151). The LED wires (151) are connected electrically to the AC contacts (1121, 1122) of the base (12).

The AC LED light source (15) may be an AC LED module and has at least one AC LED chip and a heat dissipating base. The at least one AC LED chip is packaged on the heat dissipating base. The heat dissipating base is attached to the heat sink (14).

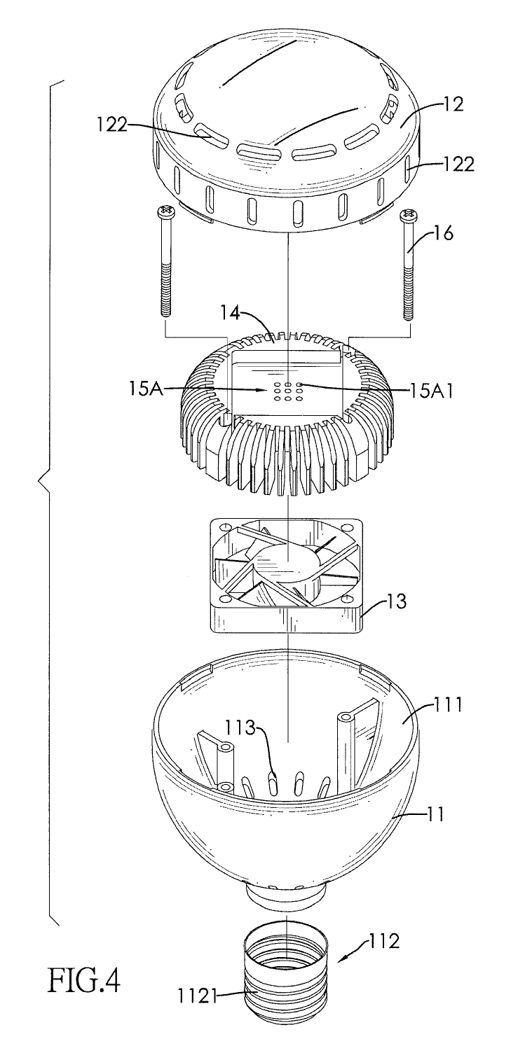

With further reference to FIG. 4, the AC LED light source (15A) may have at least one AC LED chip (15A1). The at least one AC LED chip (15A1) may be packaged on the heat sink (14). Thus, the heat dissipating base is saved and the heat sink (14) directly dissipating heat of the at least one chip (15A1) has better heat dissipating efficiency.

The LED lamp as described has the following advantages. Since an AC provided by a domestic power supply directly drives the AC LED light source (15, 15A) and the AC fan (13), no energy waste occurs and no unnecessary heat generates while rectifying current. Besides, the AC fan (13) dissipates heat of the AC LED light source (15, 15A) and the heat sink (14) out of the seat (11) through the rear and front vents (113, 122) of the seat (11) and the cover (12). Therefore, the LED lamp without a converter module has low manufacturing costs and a prolonged operating life. Moreover, as no more heat generated from the converter module, the AC fan (13) for the LED lamp is able to have lower rotational speeds with lower noise.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. The light emitting diode (LED) lamp comprising
a seat having
a mounting recess formed in a top of the seat; and
a base mounted on a bottom of the seat and having two AC contacts;
a cover mounted on the top of the seat; and
an AC LED light source mounted in the mounting recess of the seat and having two LED wires respectively connected electrically to the AC contacts of the base.

2. The LED lamp as claimed in claim 1, wherein the AC LED light source is an AC LED module.

3. The LED lamp as claimed in claim 1, wherein the AC LED light source has at least one AC LED chip.

4. The LED lamp as claimed in claim 1, wherein the cover further has a lens being transparent and corresponding to the AC LED module.

5. The LED lamp as claimed in claim 1 further comprising a heat sink mounted in the mounting recess of the seat and having a storing recess formed in a top of the heat sink and corresponding to the cover, wherein
the AC LED light source is securely mounted in the storing recess of the heat sink.

6. The LED lamp as claimed in claim 2 further comprising a heat sink mounted in the mounting recess of the seat and having a storing recess formed in a top of the heat sink and corresponding to the cover, wherein
the AC LED light source is securely mounted in the storing recess of the heat sink.

7. The LED lamp as claimed in claim 3 further comprising a heat sink mounted in the mounting recess of the seat and having a storing recess formed in a top of the heat sink and corresponding to the cover, wherein
the AC LED light source is securely mounted in the storing recess of the heat sink.

8. The LED lamp as claimed in claim 4 further comprising a heat sink mounted in the mounting recess of the seat and having a storing recess formed in a top of the heat sink and corresponding to the cover, wherein
the AC LED light source is securely mounted in the storing recess of the heat sink.

9. The LED lamp as claimed in claim 5, wherein the heat sink further has multiple fins.

10. The LED lamp as claimed in claim 6, wherein the heat sink further has multiple fins.

11. The LED lamp as claimed in claim 7, wherein the heat sink further has multiple fins.

12. The LED lamp as claimed in claim 8, wherein the heat sink further has multiple fins.

13. The LED lamp as claimed in claim 1, wherein
the LED lamp further has an AC fan mounted in the mounting recess of the seat and having two fan wires respectively connected electrically to the AC contacts of the base.

14. The LED lamp as claimed in claim 2, wherein
the LED lamp further has an AC fan mounted in the mounting recess of the seat and having two fan wires respectively connected electrically to the AC contacts of the base.

15. The LED lamp as claimed in claim 3, wherein the LED lamp further has an AC fan mounted in the mounting recess of the seat and having two fan wires respectively connected electrically to the AC contacts of the base.

16. The LED lamp as claimed in claim 4, wherein the LED lamp further has an AC fan mounted in the mounting recess of the seat and having two fan wires respectively connected electrically to the AC contacts of the base.

17. The LED lamp as claimed in claim 5, wherein
the seat further has multiple rear vents formed through the seat and communicate with the mounting recess;
the cover further has multiple front vents formed through the cover;
the LED lamp further has an AC fan mounted in the mounting recess of the seat and having two fan wires respectively connected electrically to the AC contacts of the base; and
the heat sink is mounted between the cover and the AC fan.

18. The LED lamp as claimed in claim 6, wherein
the seat further has multiple rear vents formed through the seat and communicate with the mounting recess;
the cover further has multiple front vents formed through the cover;
the LED lamp further has an AC fan mounted in the mounting recess of the seat and having two fan wires respectively connected electrically to the AC contacts of the base; and
the heat sink is mounted between the cover and the AC fan.

19. The LED lamp as claimed in claim 7, wherein
the seat further has multiple rear vents formed through the seat and communicate with the mounting recess;
the cover further has multiple front vents formed through the cover;
the LED lamp further has an AC fan mounted in the mounting recess of the seat and having two fan wires respectively connected electrically to the AC contacts of the base; and
the heat sink is mounted between the cover and the AC fan.

20. The LED lamp as claimed in claim 8, wherein
the seat further has multiple rear vents formed through the seat and communicate with the mounting recess;
the cover further has multiple front vents formed through the cover;
the LED lamp further has an AC fan mounted in the mounting recess of the seat and having two fan wires respectively connected electrically to the AC contacts of the base; and
the heat sink is mounted between the cover and the AC fan.
